(19) United States
(12) Patent Application Publication
(10) Pub. No.: US 2023/0260729 A1
(43) Pub. Date: Aug. 17, 2023

(54) Latched Electromechanical Relay

(71) Applicant: Solaredge Technologies Ltd., Herzeliya (IL)

(72) Inventor: Bryon Roos Gomberg, Kfar Saba (IL)

(21) Appl. No.: 18/170,135

(22) Filed: Feb. 16, 2023

Related U.S. Application Data
(60) Provisional application No. 63/310,849, filed on Feb. 16, 2022.

(51) Int. Cl. H01H 50/56; H01H 50/02; H01H 50/14; H01H 50/44; H01H 50/18

(52) U.S. Cl. CPC H01H 50/56; H01H 50/02; H01H 50/14; H01H 50/44; H01H 50/18

(57) ABSTRACT

An electromechanical relay may comprise a housing and one or more terminal pairs. Each terminal pair may comprise a first terminal connected to a first contact, a second terminal connected to a second contact, a first armature connected to a first coil and coupled to the first contact, and/or a second armature connected to a second coil and coupled to the second contact. Supplying power to the first and the second coils may enable movements of the first and the second contacts by moving the first and the second armatures, thereby resulting in an electrical connection between the first and the second contacts. Removing the power may comprise the first contact to be isolated from the second contact. A central armature lock may be inserted through the housing and into the recesses of each of the first and second armatures, which may reduce movement of the armatures.

### CROSS-REFERENCE TO RELATED APPLICATIONS

The present application is a non-provisional of and claims priority to U.S. Provisional Application No. 63/310,849 filed Feb. 16, 2022. The entire disclosure of the foregoing application is incorporated by reference in its entirety.

### BACKGROUND

The following disclosure relates to the field of electrical power components, and more specifically, to electromechanical relays.

Electromechanical relays may be used in a variety of power applications, such as contactors, switches, safety mechanisms, and the like. Electromechanical relays may use an electromagnetic coil to change the position of an armature, where the armature may mechanically change the position of a spring contact (e.g., such as a deflectable leaf spring contact) between a first connected state and a second connected state. For example, the first connected state may be an open circuit between two contact terminals, and the second connected state may be a closed circuit between the two contact terminals. In this manner, a controller may electrically connect or disconnect between the two contact terminals by sending or not sending a control signal to the electromagnetic coil. The base of the spring contact may be electrically connected to a first contact terminal. When the control signal is applied to the coil, a force may be applied using the armature to the contact spring. The contract spring may be bent by this force and connect with a first contact point. The first contact point may be electrically connected to a second contact terminal. When the control signal is removed from the coil, the spring contact may return to the unbent shape, possibly connecting to a second contact point. The second contact point may be connected to a third contact terminal. A single electromagnetic coil may control multiple spring contacts using an armature configured for mechanically controlling the multiple spring contacts.

### BRIEF SUMMARY

The following presents a simplified summary of some of the inventive concepts described herein. This summary is provided for illustrative purposes only and is not an extensive overview. It is not intended to identify key or critical elements, or to delineate the scope of the present disclosure.

Disclosed are methods, devices and systems for controlling multiple contacts (e.g., deflectable contacts, sprint contacts, leaf contacts, etc.) in a multi-line electromechanical relay with a dual coil configuration. Each coil in the dual coil configuration may be used to control multiple contacts, and each contact of the first coil of the dual coil configuration may correspond to another contact of the other coil of the dual coil configuration in a serial manner. The two contacts of the two coils in the dual-coil configuration may be connected to two terminals. Thus, each line of the multi-line relay may have two contacts (e.g., each coil controlling one of the two contacts) in series. The armatures for each coil may be positioned at the center of the relay and connected to the contacts. The contacts for each line may be positioned to face each other in an inverted fashion, such that one contact is pulled up by one of the coils in the dual coil configuration, and the other contact for the same line is pulled down by the other coil in the dual coil configuration. The relay may further comprise a conducting block between the two contacts in each line, such that the moveable ends of each of the two contacts in each line may electrically connect to different sides of the conducting block. Alternatively, the relay may not use the conducting block, and the moveable ends of the two contacts in each line may electrically connect by directly connecting to each other. A central latching mechanism may be used to latch or lock the armatures in position so that the contacts are forced open by the armatures.

### BRIEF DESCRIPTION OF THE DRAWINGS

Some features are shown by way of example, and not by limitation, in the accompanying drawings. In the drawings, like numerals reference similar elements.

FIG. 1A shows an example multi-line electromechanical relay with center contact conductors in an open configuration.

FIG. 1B shows the example multi-line electromechanical of FIG. 1A in a closed configuration.

FIG. 2A shows an example multi-line electromechanical relay without center contact conductors in an open configuration.

FIG. 2B shows the example multi-line electromechanical relay in FIG. 2A in a closed configuration.

### DETAILED DESCRIPTION

In the following description of the various embodiments, reference is made to the accompanying drawings, which form a part hereof, and in which is shown by way of illustration various embodiments in which the present disclosure may be practiced. It is to be understood that other embodiments may be utilized, and structural and functional modifications may be made without departing from the scope of the present disclosure. Unless defined otherwise, all technical and scientific terms used herein have the same meaning as commonly understood by one of ordinary skill in the art.

Disclosed herein are electromechanical relays that may be used to electrically connect and/or isolate terminals receiving one or more phases of power (e.g., terminals providing three phases of an alternating current power). An electromechanical relay may comprise a pair of contacts (e.g., deflectable contacts, sprint contacts, leaf contacts, etc.) for a pair of terminals receiving power of a specific phase. For example, one terminal of a pair of terminals may be connected to a left-side contact, and the other terminal of the pair of terminals may be connected to a right-side contact. Armatures may connect the left-side contact and the right-side contact at the center of the relay housing (e.g., instead of at the sides of the relay housing) and/or isolate the left-side contact from the right-side contact. The armatures may be placed in the center of the housing by configuring the left-side contact to face the right-side contact in a rotationally symmetrical manner (e.g., each contact facing toward the center of the relay where one contact can deflect in a first direction and the other in a second, opposite, direction). Furthermore, the configuration of the contacts facing the center may allow a direct connection between a left-side contact and a right-side contact, which may lower the serial resistance relative to conventional relays. A central armature lock may be used to prevent the relay from entering a closed configuration. The advantage of the armature lock in the center may be to simplify the commissioning of a power device that includes the relay.

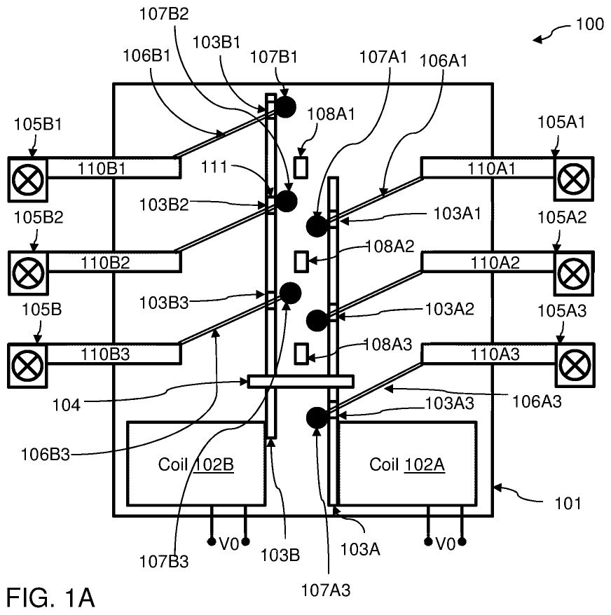

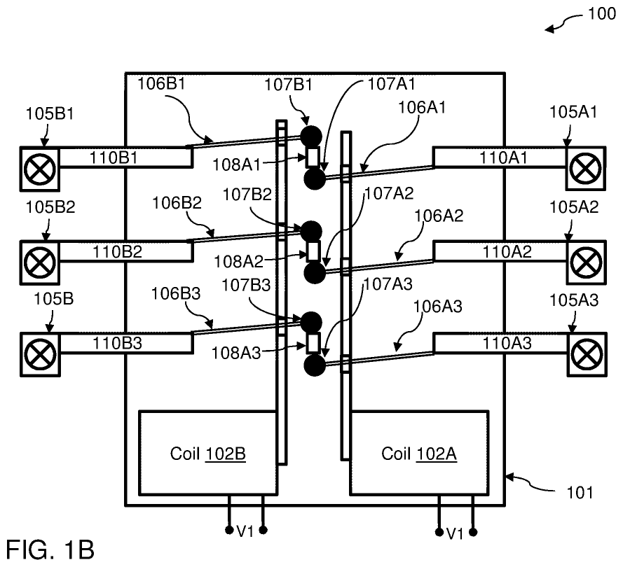

Reference is now made to FIG. 1A, which shows an example electromechanical relay 100 in an open configuration. The electromechanical relay 100 may comprise a housing 101, and a pair of terminals for each phase of an alternating current (AC) power supply. For example, the terminals 105A1 and 105B1 may receive a first phase of a three-phase AC power supply, the terminals 105A2 and 105B2 may receive a second phase of the AC power supply, and the terminals 105A3 and 105B3 for may receive a third phase of the AC power supply. This example illustration shows a three-phase relay, but other embodiments, such as a single, double, or quad-phase relay, may be manufactured similarly and may operate consistent with the description herein. Each terminal in the relay 100 may be connected to a terminal member. For example, the terminal 105A1 may be connected to the terminal bar 110A1, the terminal 105A2 may be connected to the terminal bar 110A2, the terminal 105A3 may be connected to the terminal bar 110A3, the terminal 105B1 may be connected to the terminal bar 110B1, the terminal 105B2 may be connected to the terminal bar 110B2, and/or the terminal 105B3 may be connected to the terminal bar 110B3. Each terminal bar may comprise an inner portion that is disposed or located inside the housing 101 and/or an outer portion that is disposed or located outside the housing 101.

The relay 100 may comprise a pair of contacts (e.g., deflectable contacts, spring contacts, leaf contacts, etc.) for each phase of the relay 100. For example, the contact 106A1 may be connected to the terminal 105A1 via the terminal member 110A1, the contact 106A2 may be connected to the terminal 105A2 via the terminal member 110A2, the contact 106A3 may be connected to the terminal 105A3 via the terminal member 110A3, the contact 106B1 may be connected to the terminal 105B1 via the terminal member 110B1, the contact 106B2 may be connected to the terminal 105B2 via the terminal member 110B2, and/or the contact 106B3 may be connected to the terminal 105B3 via the terminal member 110B3. The contacts 106A1 and 106B1 may form a first pair of contacts that receive a first phase of the three-phase AC power supply, the contacts 106A2 and 106B1 may form a second pair of contacts that receive the second phase, and the contacts 106A3 and 106B3 may form a third pair of contacts that receive the third phase. Each contact may be connected, attached, or hingedly mounted to the inner portion of the respective terminal members. A fixed end of each contact may be connected to the inner portion of the respective terminal member. A moveable end of each contact may be facing the center of the housing 101.

Two coils 102A and 102B may operate attached armatures 103A and 103B. The contacts 106A1, 106A2, and/or 106A3 may be connected, attached, or hingedly mounted to the armatures 103A, while the contacts 106B1, 106B2, and/or 106B3 may be connected, attached, or hingedly mounted to the armatures 103B. Furthermore, the armatures 103A and 103B may comprise multiple slots (e.g., the slot 111), and the contacts may be coupled to the armatures by inserting the contracts through the slots.

The pairs of contacts may face each other in a rotationally symmetrical manner. For example, if the conductor 108A is considered the midpoint between the fixed end of the contact 106A1 and the contact 106B1, the contact 106A1 may be in the position of the contact 106B1 if the contact 106A1 is rotated 180 degrees in a clockwise or anti-clockwise direction relative to the midpoint. Similarly, the contact 106B1 may be in the position of the contact 106A1 if the contact 106B1 is rotated 180 degrees in a clockwise or anti-clockwise direction relative to the midpoint. The contacts 106A1 and 106B1 may face each other, the contacts 106A2 and 106B2 may face each other, and/or the contacts 106A3 and 106B3 may face each other. The contacts 106B1, 106B2, and 106B3 on the left side of the relay 100 may move towards the coil 102B to make electrical connections with the contacts 106A1, 106A2, and 106A3, and the contacts 106A1, 106A2, and 106A3 on the right side of the relay 100 may move away from the coil 102A to make electrical connections with the contacts 106B1, 106B2, and 106B3. Each contact may have a contact element 107A1, 107A2, 107A3, 107B1, 107B2, or 107B3, which may be attached at the moveable end of the respective contact. The contact elements may be enlarged compared to the respective contact's moveable end. Conductors 108A1, 108A2, and 108A3 may be located between the terminal members and/or between pairs of contacts. For example, the conductor 108A1 may be disposed between the terminal members 110A1 and 110B1, the conductor 108A2 may be disposed between the terminal members 110A2 and 110B2, and/or the conductor 108A3 may be disposed between the terminal members 110A3 and 110B3. The relay of FIG. 1A may be in an open configuration when a voltage (e.g., voltage V0) applied between activation terminals of each of coils 102A and 102B satisfies a threshold voltage (e.g., the applied voltage V0 is above a threshold voltage). In some examples, the voltage applied at the activation terminals of the coil 102B may be the same as the voltage applied at the activation terminals of the coil 102A. In the open configuration, the contacts 106A1 and 106B1 may be electrically isolated from the conductor 108A1, the contacts 106A2 and 106B2 may be electrically isolated from the conductor 108A2, and/or contacts 106A3 and 106B3 may be electrically isolated from the conductor 108A3. Therefore, in the open condition, the terminal 105A1 is electrically isolated from the terminal 105B1, the terminal 105A2 is electrically isolated from the terminal 105B2, and/or the terminal 105A3 is electrically isolated from the terminal 105B3.

The relay 100 may be in a locked condition or an unlocked condition. During the locked condition, the relay 100 cannot switch from an open condition to a closed condition or switch from a closed condition to an open condition. While in an unlocked condition, the relay 100 may switch between the open and closed conditions. A central locking element 104 may be located at the center of the housing and span the two armatures 103A and 103B. The central locking element 104 may comprise a lock pin that may be inserted into recesses in the two armatures 103A and 103B to restrict the armatures from moving, thereby putting the relay 100 into a locked condition. The central locking element 104 may be a mechanical safety lock that physically prevents the contacts from closing or connecting by locking the positions of the actuators in place 103A and 103B until the lock pin of the central locking element 104 is removed from the recesses of the two armatures 103A and 103B to put the relay 100 into an unlocked position. Removing the lock pin may include removing the lock pin from the inside of the housing 101 to the outside of the housing 101 through a wall of the housing 101. The lock pin may be removed after the relay 101 is connected to a power device and/or an electrical network, and the relay 100 is ready to be turned on or used for the first time. Releasing the lock pin should not change the rating and certification compliances of the relay 100. The lock pin may be accessible from outside the housing 101, such as a string attached to the lock pin and leading outside the housing 101.

FIG. 1B shows the relay 100 of FIG. 1B in a closed configuration. When the lock pin of the central locking element 104 is removed, and/or a voltage V1 is applied to each of coils 102A and 102B, the coils 102A and 102B may produce changes in the positions of the armatures 103A and 103B. The coils 102A and 102B may produce changes in the positions of the armatures 103A and 103B if the applied voltage V1 is above a threshold voltage. The change in the positions of armatures 103A and 103B may cause changes in the positions of contacts 106A1, 106A2, 106A3, 106B1, 106B2, and 106B3, which may result in an electrical connection between the contact elements 107A1, 107A2, 107A3, 107B1, 107B2, and 107B3 and the conductors 108A1, 108A2, and 108A3. For example, the contact element 107A1 may be in contact with the top portion or surface of the conductor 108A1, while the contact element 107B2 may be in contact with the bottom portion or surface of the conductor 108A1. As an example of a closed configuration, the terminal 105A1 may be electrically connected to 108A1 and may be further connected to the terminal 105B1, which may establish an electrical short-circuit connection between the terminals 105A1 and 105B1. As an example of other phases in the closed configuration, the terminal 105A2 may be electrically connected to the terminal 105B2, and the terminal 105A3 may be electrically connected to the terminal 105B3.

In some examples, the contacts 106A1, 106A2, 106A3, 106B1, 106B2, and 106B3 may comprise spring contacts. When the relay 100 is in a closed configuration, the resiliencies of the spring contacts may apply a mechanical bias to a connection between the spring contacts when the relay 100 is in a closed configuration.

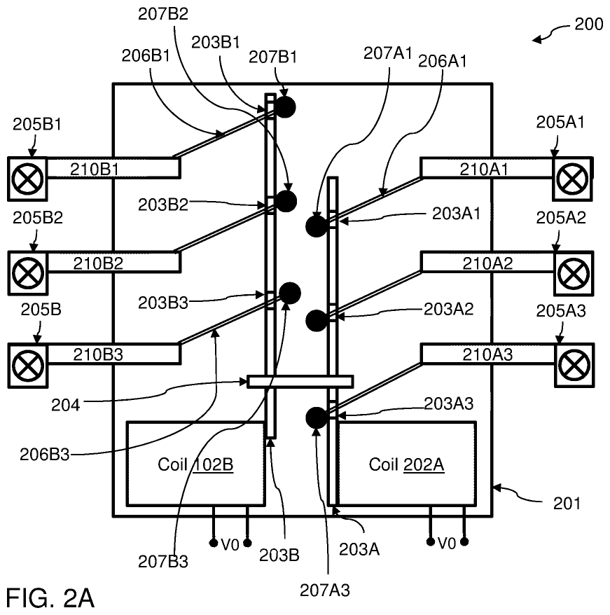

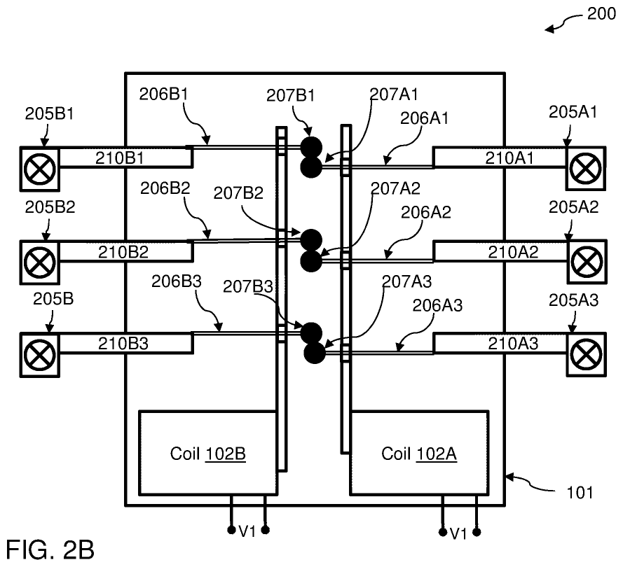

Reference is now made to FIG. 2A, which shows an example electromechanical relay 200 in an open configuration. The electromechanical relay 200 may comprise all the elements of the relay 100 in FIG. 1A and FIG. 1B except for the conductors 108A1, 108A2, and/or 108A3. For example, the relay 200 may comprise a housing 201, and a pair of terminals for each phase of an alternating current supply, such as 205A1 and 205B1 for a first phase, 205A2 and 205B2 for a second phase, and 205A3 and 205B3 for a third phase. This example illustration shows a three-phase relay, but a single, double, or quad phase relay may be manufactured similarly. Each of the terminals may be connected to a terminal bar. For example, the terminal 205A1 may be connected to the terminal bar 210A1, the terminal 205A2 may be connected to the terminal bar 210A2, the terminal 205A3 may be connected to the terminal bar 210A3, the terminal 205B1 may be connected to the terminal bar 210B1, the terminal 205B2 may be connected to the terminal bar 210B2, and/or the terminal 205B3 may be connected to the terminal bar 210B3. Each terminal bar may comprise an inner portion that is disposed or located inside the housing 101 and/or an outer portion that is disposed or located outside the housing 101.

Contacts (e.g., deflectable contacts, spring contacts, leaf contacts, etc.), with two in series for each phase of the relay (e.g., 206A1, 206A2, 206A3, 206B1, 206B2, and 206B3), may be located on or attached to the inner portions of the terminal members. A fixed end of each contact may be connected to the inner portion of the respective terminal member. A moveable end of each contact may be facing the center of the housing 201. Two coils 202A and 202B may operate attached armatures 203A and 203B, which may be attached in turn to each of the contacts 206A1, 206A2, 206A3, 206B1, 206B2, and 206B3. The contacts 206A1, 206A2, 206A3, 206B1, 206B2, and 206B3 may face each other in a rotationally symmetrical manner. For example, the contact 206A1 may be in the position of the contact 206B1 if the contact 206A1 is rotated 180 degrees in a clockwise or anti-clockwise direction relative to a midpoint between the contacts 206A1 and 206B1. Similarly, the contact 206B1 may be in the position of the contact 206A1 if the contact 206B1 is rotated 180 degrees in a clockwise or anti-clockwise direction relative to the midpoint. The contacts 206B1, 206B2, and 206B3 on the left side of the relay 200 may move towards the coil 202B to make electrical connections with the contacts 206A1, 206A2, and 206A3, and the contacts 206A1, 206A2, and 206A3 on the right side of the relay may move away from the coil 202A to make electrical connections with the contacts 206B1, 206B2, and 206B3. Each contact may have a contact element 207A1, 207A2, 207A3, 207B1, 207B2, and 207B3, which may be attached at the moveable end of the respective contact. A central locking element 204 may be located at the center of the housing and may span the two armatures 203A and 203B. The central locking element 204 may be inserted into recesses in the two armatures 203A and 203B, which may restrict the armatures from moving.

The relay 200 of FIG. 2A may be in an open configuration when a voltage (e.g., voltage V0) applied between activation terminals of each of coils 202A and 202B does not satisfy a threshold voltage (e.g., the applied voltage V0 is below a threshold voltage). In the open configuration, the contact 206A1 may be electrically isolated from the contact 206B1, the contact 206A2 may be electrically isolated from the contact 206B2, and/or the contact 206A3 may be electrically isolated from the contact 206B3. Therefore, in the open condition, the terminal 205A1 is electrically isolated from the terminal 205B1, the terminal 205A2 is electrically isolated from the terminal 205B2, and/or the terminal 205A3 is electrically isolated from the terminal 205B3.

Reference is now made to FIG. 2B, which shows the relay 200 in FIG. 2A in a closed configuration. When the lock pin of the central locking element 204 is removed, and/or a voltage V1 (e.g., a voltage that satisfies or is above a threshold voltage) is applied to each of coils 202A and 202B, the coils may change the position of the armatures 203A and 203B. The changes in the positions of the armatures 203A and 203B may cause changes in the positions of contacts 206A1, 206A2, 206A3, 206B1, 206B2, and 206B3, which may result in an electrical connection between contact elements 207A1, 207A2, 207A3, 207B1, 207B2, and 207B3. For example, the contact element 207A1 may be in contact or electrically connected to the contact element 207B1, the contact element 207A2 may be in contact or electrically connected to the contact element 207B2, and/or the contact element 207A3 may be in contact or electrically connected to the contact element 207B3. As an example of a closed configuration, an electrical short-circuit connection may establish between the terminals 205A1 and 205B1. As an example of other phases in a closed configuration, the terminal 205A2 may be electrically connected to the terminal 205B2, and the terminal 205A3 may be electrically connected to the terminal 205B3.

The relays 100 and 200 may be configured as normally open relays or normally closed relays. For example, the contacts 106A1, 106A2, 106A3, 106B1, 106B2, and/or 106B3 in FIG. 1A and the contacts 206A1, 206A2, 206A3, 206B1, 206B2, and/or 206B3 in FIG. 2A may be normally open when a zero voltage (e.g., no voltage or V1 is zero) is applied to the coils 102A, 102B, 202A, and 202B, and may switch to a closed position when a non-zero voltage is applied to the coils 102A, 102B, 202A, and 202B. In other examples, the contacts may be normally closed when a zero voltage (e.g., no voltage or V1 is zero) is applied to the coils and may switch to an open configuration when a non-zero voltage is applied to the coils.

Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing the claims. The present application also discloses the subject matter of the following clauses.

Clause 1 A electromechanical relay comprising:

a housing comprising a plurality of terminal pairs arranged laterally on two sides of the housing, wherein the plurality of terminal pairs are arranged with one of each terminal pair on a left side of the housing and the other of each terminal pair on a right side of the housing, each terminal pair transecting the housing and comprising an inner portion and an outer portion;

a first coil and a second coil, each of the first coil and second coil comprising activation terminals;

a first armature and a second armature, wherein one end of the first armature is attached to the first coil, and one end of the second armature is attached to the second coil;

a plurality of spring contacts, each comprising a fixed end and a moveable end, wherein the fixed end of each of the plurality of spring contacts is attached on each of the inner portions, wherein each moveable end is facing a center of the housing, and wherein each of the spring contacts is attached to one of the first and second armature; and a central armature lock, wherein the central armature lock is inserted through the housing and into recesses of each of the first and second armatures, thereby reducing movement of the armatures.

Clause 2: The electromechanical relay of clause 1, wherein the plurality of spring contacts, the first coil, the second coil, the first armature, and the second armature may be configured in an open configuration and a closed configuration.

Clause 3: The electromechanical relay of clause 2, wherein, in the closed configuration, the plurality of spring contacts are configured to provide an electrical short-circuit connection between the one and the other of each pair of the plurality of terminal pairs.

Clause 4: The electromechanical relay of clause 2, wherein in the open configuration the plurality of spring contacts are configured to provide an electrically isolated connection between the one and the other of each pair of the plurality of terminal pairs.

Clause 5: The electromechanical relay of clause 2, wherein, in the open configuration, the central lock mechanism restricts motion of the armatures and thereby prevents changing from the open configuration to the closed configuration.

Clause 6: The electromechanical relay of clause 1, further comprising a plurality of conductors, wherein each conductor of the plurality of conductors is arranged between the inner portions of each pair of the plurality of terminal pairs, and wherein each conductor of the plurality of conductors is located between the respective spring contacts of the plurality of spring contacts.

Clause 7: The electromechanical relay of clause 1, wherein a contact element is attached to each moveable end of the plurality of spring contacts.

1. An electromechanical relay comprising:
a housing;
at least one terminal pair comprising a first terminal and a second terminal, wherein the terminal pair is arranged with the first terminal on a first side of the housing and the second terminal on a second side of the housing;
a first armature and a second armature;
a first contact having a fixed end attached to the first terminal, and having a moveable end coupled to the first armature;
a second contact having a fixed end attached to the second terminal, and having a moveable end coupled to the second armature;
a first coil configured to move, responsive to power being supplied to the first coil, the first armature, thereby moving the moveable end of the first contact coupled thereto;
a second coil configured to move, responsive to the power being supplied to the second coil, the second armature, thereby moving the moveable end of the second contact coupled thereto; and
a central armature lock manually actuatable, from outside the housing, between a locked condition and an unlocked condition, wherein the central armature lock comprises a locking pin which, in the locked condition, restricts the movements of the first and the second armatures.

2. The electromechanical relay of claim 1, wherein the electromechanical relay is configured to switch, based on the power being supplied to the first coil and the second coil, between an open configuration and a closed configuration,
wherein the closed configuration comprises the first and the second armatures being positioned such that the first and the second terminals are electrically connected, and
wherein the open configuration comprises the first and the second armatures being positioned such that the first and the second terminals are electrically isolated.

3. The electromechanical relay of claim 2, wherein the electromechanical relay is configured to switch, based on the power being supplied to the first coil and the second coil, from the open configuration to the closed configuration by moving the first and the second armatures to electrically connect the first contact with the second contact.

4. The electromechanical relay of claim 2, wherein the electromechanical relay is configured to switch, based on the power being supplied to the first coil and the second coil, from the closed configuration to the open configuration by moving the first and the second armatures to electrically isolate the first contact with the second contact.

5. The electromechanical relay of claim 2, further comprising at least one conductor disposed between the first terminal and second terminal.

6. The electromechanical relay of claim 5, wherein the electromechanical relay is configured to switch, based on the power being supplied to the first coil and the second coil, from the open configuration to the closed configuration by moving the first and the second armatures to electrically connect the first contact and the second contact to the at least one conductor.

7. The electromechanical relay of claim 5, wherein the electromechanical relay is configured to switch, based on the power being supplied to the first coil and the second coil, from the closed configuration to the open configuration by moving the first and the second armatures to electrically isolate the first contact and the second contact from the at least one conductor.

8. The electromechanical relay of claim 1, wherein the first contact comprises a first spring contact and the second contacts comprises a second spring contact.

9. The electromechanical relay of claim 8, wherein, in a closed configuration, a first resilience of the first spring contact and a second resilience of the second spring contact apply mechanical biases to a connection between the first and the second spring contacts.

10. The electromechanical relay of claim 1, wherein the moveable ends of the first and the second contacts are attached to contact elements.

11. The electromechanical relay of claim 1, further comprising:
a first terminal member connecting the first terminal to the fixed end of the first contact; and
a second terminal member connecting the second terminal to the fixed end of the second contact.

12. The electromechanical relay of claim 11, wherein each of the first and the second terminal members transects a respective wall of the housing, and comprises an inner portion disposed inside the housing and an outer portion disposed outside the housing,
wherein the fixed end of the first contact is attached to the inner portion of the first terminal member, and
wherein the fixed end of the second contact is attached to the inner portion of the second terminal member.

13. The electromechanical relay of claim 12, wherein the first contact and the second contact are configured to face each other and switch from the open configuration to the closed configuration in a rotationally symmetrical orientation.

14. The electromechanical relay of claim 1, wherein each of the first and the second armatures comprises a recess, and
wherein, in the locked condition, the locking pin is positioned in the recess of each of the first and the second armatures.

15. The electromechanical relay of claim 14, wherein the locking pin, in the locked condition, transects through a wall of the housing.

16. The electromechanical relay of claim 1, wherein the locking pin is completely removable from the housing.

17. The electromechanical relay of claim 1, wherein, in the locked condition, the locking pin has a portion extending outside of the housing to enable the manual actuation from the outside of the housing to move the central armature lock between the locked condition to the unlocked condition.

18. The electromechanical relay of claim 1, further comprising:
a first terminal pair, a second terminal pair, and a third terminal pair,
wherein the first terminal pair is configured to receive a first phase of an alternating current (AC) power,
wherein the second terminal pair is configured to receive a second phase of the AC power, and
wherein the third terminal pair is configured to receive a third phase of the AC power.

19. The electromechanical relay of claim 1, wherein one end of the first armature is attached to the first coil, and one end of the second armature is attached to the second coil.

20. The electromechanical relay of claim 1, wherein each of the first and the second armatures comprises a slot,
wherein the first contact is inserted through the slot of the first armature, and
wherein the second contact is inserted through the slot of the second armature.
